(19) United States
(12) Patent Application Publication
(10) Pub. No.: US 2024/0212269 A1
(43) Pub. Date: Jun. 27, 2024

(54) INFORMATION PROCESSING APPARATUS, INFORMATION PROCESSING METHOD, PROGRAM, AND INFORMATION PROCESSING SYSTEM

(71) Applicant: SONY GROUP CORPORATION, TOKYO (JP)

(72) Inventors: KEIICHIRO TANIGUCHI, TOKYO (JP); TAKUYA IKEDA, TOKYO (JP); HONOKA OZAKI, TOKYO (JP)

(21) Appl. No.: 18/556,984

(22) PCT Filed: Jan. 12, 2022
(86) PCT No.: PCT/JP2022/000679

§ 371 Date: Oct. 24, 2023

(30) Foreign Application Priority Data
May 17, 2021 (JP) 2021-083320

(51) Int. Cl. G06T 17/00; G06T 7/50; G06T 7/90; G06V 10/60; H04N 13/279; H04N 13/363

(52) U.S. Cl. CPC G06T 17/00; G06T 7/50; G06T 7/90; G06V 10/60; H04N 13/279; H04N 13/363; G06V 2201/07

(57) ABSTRACT

An information processing apparatus according to an embodiment of the present technology includes a generation unit. The generation unit generates, on the basis of region information related to a projection region on which a virtual object is projected, other region information related to another projection region different from the projection region, and position information of an obstacle that interferes with projection of the virtual object in at least one of the projection region or the other projection region, a common region to the projection region and the other projection region, the common region not including the obstacle.

### TECHNICAL FIELD

The present technology relates to an information processing apparatus, an information processing method, a program, and an information processing system that can be applied to image display and the like.

### BACKGROUND ART

Patent Literature 1 has described an information processing apparatus that recognizes the position of an irradiation point of a laser pointer with respect to a projection image on a local side. Information about a remote irradiation point at a coordinate position corresponding to that irradiation point and a user who operates the laser pointer in addition to the projection image is sent to a remote side. This enables a smooth communication meeting connecting a plurality of remote locations (Paragraphs [0018] to [0035] in specification, FIG. 1, etc. in Patent Literature 1).

### CITATION LIST

### Patent Literature

Patent Literature 1: WO 2014/208169

### DISCLOSURE OF INVENTION

### Technical Problem

It is desirable to provide a technology capable of sharing content in a device that performs cooperative work with such a remote location in real time.

In view of the above-mentioned circumstances, it is an objective of the present technology to provide an information processing apparatus, an information processing method, a program, and an information processing system that are capable of sharing content.

### Solution to Problem

In order to accomplish the above-mentioned objective, an information processing apparatus according to an embodiment of the present technology includes a generation unit.

The generation unit generates, on the basis of region information related to a projection region on which a virtual object is projected, other region information related to another projection region different from the projection region, and position information of an obstacle that interferes with projection of the virtual object in at least one of the projection region or the other projection region, a common region to the projection region and the other projection region, the common region not including the obstacle.

With this information processing apparatus, the common region to the projection region and the other projection region, which does not include the obstacle, is generated on the basis of the region information related to the projection region on which the virtual object is projected, the other region information related to the other projection region different from the projection region, and the position information of the obstacle that interferes with projection of the virtual object in the at least one of the projection region or the other projection region. This enables content sharing.

The region information may include a dimension of the projection region, an area of the projection region, a position of the projection region, and a shape of the projection region. In this case, the other region information may include a dimension of the other projection region, an area of the other projection region, a position of the other projection region, and a shape of the other projection region.

The information processing apparatus may include a detection unit that detects the obstacle.

The detection unit may detect the object as the obstacle on the basis of object information related to an object included in the projection region.

The object information may include a depth of the object, a tilt of the object, a material of the object, a color of the object, and brightness of the object.

The detection unit may detect the object having a depth different from the depth of the projection region as the obstacle.

The projection region may include a center point. In this case, the other projection region may include another center point. Moreover, the generation unit may make the center point and the other center point overlap each other and generate the common region.

The generation unit may generate the common region with an identical dimension on the basis of a dimension of the projection region and a dimension of the other projection region.

The generation unit may make the center point and the other center point overlap each other and generate a region in which the projection region and the other projection region overlap each other as the common region.

The information processing apparatus may include a determination unit that determines whether or not an area of the common region encompasses the virtual object.

The determination unit may determine whether or not an area of the common region is equal to or larger than a threshold value.

The information processing apparatus may further include a notification unit that notifies of an error on the basis of a determination result of the determination unit.

An information processing method according to an embodiment of the present technology is an information processing method including
by a computer system
generating, on the basis of region information related to a projection region on which a virtual object is projected, other region information related to another projection region different from the projection region, and position information of an obstacle that interferes with projection of the virtual object in at least one of the projection region or the other projection region, a common region to the projection region and the other projection region, the common region not including the obstacle.

A recording medium on which a program according to an embodiment of the present technology is written causes a computer system to execute the following step.

A step of generating, on the basis of region information related to a projection region on which a virtual object is projected, other region information related to another projection region different from the projection region, and position information of an obstacle that interferes with projection of the virtual object in at least one of the projection region or the other projection region, a common region to the projection region and the other projection region, the common region not including the obstacle.

An information processing system according to an embodiment of the present technology includes a camera, an information processing apparatus, and an image generation unit.

The camera images a projection region on which a virtual object is projected.

The information processing apparatus includes a generation unit that generates, on the basis of region information related to a projection region on which a virtual object is projected, other region information related to another projection region different from the projection region, and position information of an obstacle that interferes with projection of the virtual object in at least one of the projection region or the other projection region, a common region to the projection region and the other projection region, the common region not including the obstacle.

The image generation unit projects the virtual object.

The information processing system may further include
a communication unit that sends and receives data to and from another information processing system including
   another camera that images the other projection region on which the virtual object is projected,
   another information processing apparatus including another generation unit that generates the common region on the basis of the region information, the other region information, and the position information, and
   another image generation unit that projects the virtual object.

The communication unit may send the region information and the position information to the other information processing system and receive the other region information and the position information.

The image generation unit may include a projector, an augmented reality glass, and virtual reality goggles.

The information processing system may further include a distance measurement sensor that measures a distance to the projection region.

### BRIEF DESCRIPTION OF DRAWINGS

FIG. 1 A diagram schematically showing an information processing system.

FIG. 2 A flowchart showing generation of a common region.

FIG. 3 A flowchart in an example of the information processing system.

FIG. 4 A schematic view showing when a user brings an object into contact with a projection region.

FIG. 5 A schematic view showing a projection center point.

FIG. 6 A schematic view showing a calculation example of dimension information.

FIG. 7 A schematic view showing an example of an exclusively-owned projection plane.

FIG. 8 A schematic view showing an example of an exclusively-owned projection plane and another exclusively-owned projection plane.

FIG. 9 A schematic view showing an example of the common region.

FIG. 10 A schematic view showing an example of the common region.

FIG. 11 A diagram schematically showing an information processing system according to another embodiment.

FIG. 12 A schematic view showing a calculation example of dimension information in a case of using a distance measurement sensor.

FIG. 13 A block diagram showing a hardware configuration example of an information processing apparatus.

### MODE(S) FOR CARRYING OUT THE INVENTION

Hereinafter, embodiments according to the present technology will be described with reference to the drawings.

### [Configuration of Information Processing System]

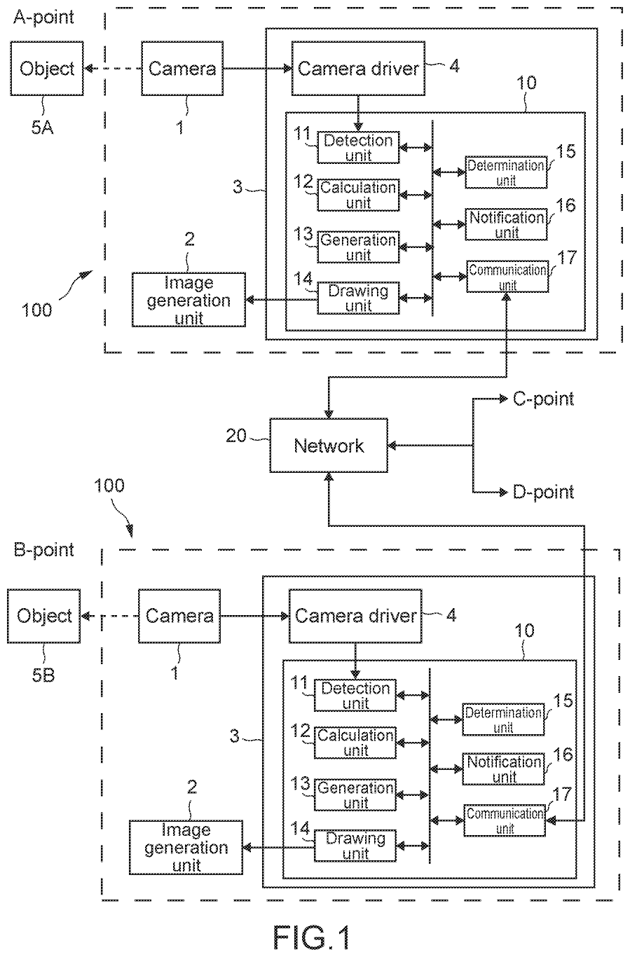

FIG. 1 is a diagram schematically showing an information processing system according to the present technology.

As shown in FIG. 1, an information processing system 100 includes a camera 1, an image generation unit 2, and a main body terminal 3. In FIG. 1, a B-point, a C-point (not shown), and a D-point (not shown) as sharing locations also have similar information processing systems 100. Hereinafter, an information processing system 100 of an A-point will be described. Moreover, the sharing locations (the B-point, the C-point, and the D-point) will be referred to as other information processing systems. For example, projection regions of the sharing locations will be referred to as other projection regions.

It should be noted that the number of information processing systems of the sharing locations are not limited.

The camera 1 captures a captured image. In the present embodiment, the camera 1 images a projection region on which the image generation unit 2 projects a virtual object and an object 5A.

The object 5A is an object having a fixed length whose physical dimensions have been recorded on the information processing system 100. For example, the object includes a pen device capable of writing on an interactive projector, a remote controller as an accessory of a projector, a smartphone, and the like. It should be noted that the object is not limited, and only needs to be an object whose physical dimensions have been recorded on the information processing system 100. It should be noted that FIG. 1 shows the object 5A used in the A-point and an object 5B used in the B-point, and the object 5A and the object 5B may be different objects or may be the same objects.

The image generation unit 2 projects a virtual object onto the projection region. For example, the image generation unit 2 is a projector or the like and an image generated by the main body terminal 3 is projected onto the projection region.

The projection region is a region on which the virtual object is projected. The projection region is a region (range) projected onto a wall or screen, on which the image generation unit 2 is capable of projection.

The main body terminal 3 includes a camera driver 4 and an information processing apparatus 10.

The camera driver 4 performs various types of control on the camera 1. In the present embodiment, the camera driver 4 controls the camera 1 to image the object 5A, an obstacle, or the like present in the projection region.

Moreover, in the present embodiment, an image captured by the camera 1 is provided to a detection unit 11.

The information processing apparatus 10 includes the detection unit 11, a calculation unit 12, a generation unit 13, a drawing unit 14, a determination unit 15, a notification unit 16, and a communication unit 17.

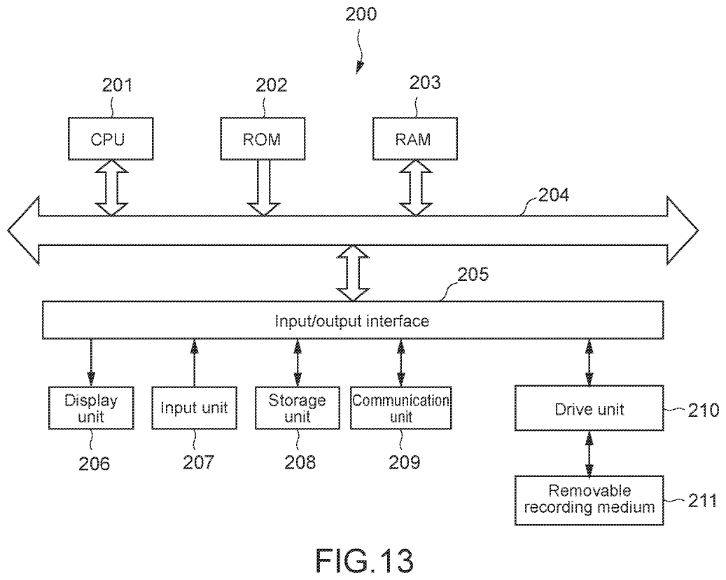

The information processing apparatus 10 has hardware required for a computer configuration, e.g., a processor such as CPU, GPU, and DSP, a memory such as ROM and RAM, and a storage device such as an HDD (see FIG. 13). For example, the CPU loading a program according to the present technology recorded in advance in the ROM or the like to the RAM and executing it executes an information processing method according to the present technology.

Any computer, e.g., a PC can achieve the information processing apparatus 10. Hardware such as FPGA and ASIC may be used as a matter of course.

In the present embodiment, the CPU executing a predetermined program configures the generation unit as a functional block. As a matter of course, dedicated hardware such as an integrated circuit (IC) may be used for achieving the functional block.

The information processing apparatus 10 installs the program via a variety of recording media, for example. Alternatively, the information processing apparatus 10 may install the program via the Internet, for example.

The type and the like of the recording medium for recording the program are not limited, and any computer-readable recording medium may be used. For example, any computer-readable non-transitory storage medium may be used.

The detection unit 11 detects the object 5A and the obstacle from an image captured by the camera 1. In the present embodiment, the detection unit 11 detects the object 5A in contact with a wall surface. That is, the detection unit 11 stores the wall surface in contact with the object 5A as a reference depth of the projection region.

Moreover, the detection unit 11 detects an object inside the projection region. In the present embodiment, the detection unit 11 detects an object as an obstacle on the basis of the object information related to the object. An object having a depth different from the depth of the wall surface (projection region) is detected as an obstacle by for example detecting irregularities inside the projection region.

In the present embodiment, the generation unit 13 is provided with position information including a region (range) in which an obstacle is present and its shape.

The obstacle refers to an object that interferes with projection of the virtual object. In the present embodiment, the object information includes a depth, a tilt, a material, a color, and brightness of the object. A region having a depth different from a depth of the wall surface (projection region) as a reference depth, which is for example furniture, an atrium, a window, or the like is detected as an obstacle. Moreover, examples of the obstacle to be detected can include a region having a tilt different from a tilt of the projection region such as a curved wall, a region having excessively high reflectance so that the projector cannot perform projection on it, such as a mirror and a gross material, a region having a rough surface so that the projector cannot perform projection on it, such as a wall surface having large irregularities, a translucent region on which projection is impossible, such as a glass and a transparent acrylic plate, a region having a color tone different from a color tone of the projection region, and a region having brightness, e.g., at a sunlight level, higher than brightness with which the projector can perform projection.

It should be noted that the user may set a depth value for recognizing the obstacle. Moreover, an object that changes in position, such as a human, may be excluded from the obstacle to be recognized.

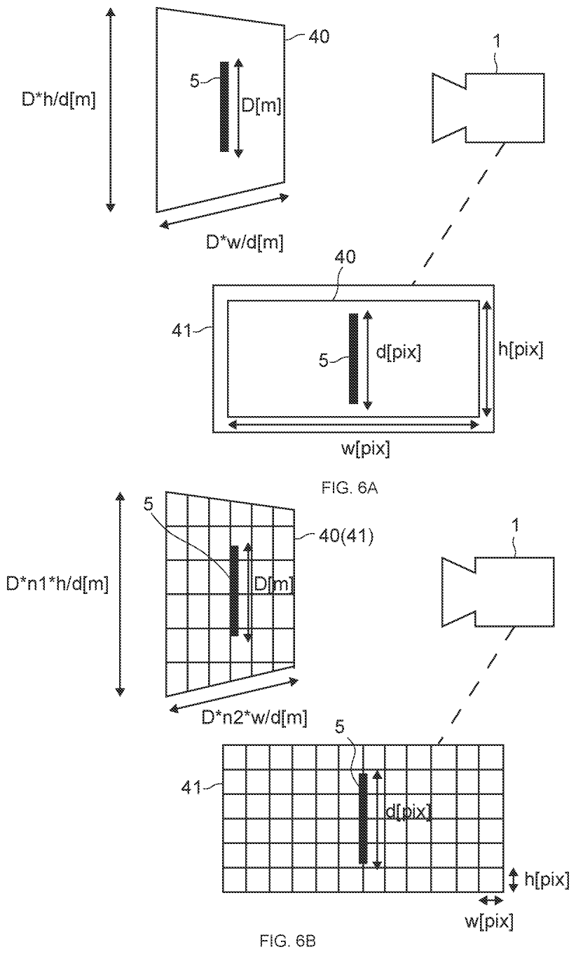

The calculation unit 12 calculates dimension information of a projection region. The dimension information refers to information related to a length of the projection region. In the present embodiment, the projection region is rectangular, and thus the dimension information is lengths of shorter and longer sides of the projection region. A specific calculation method will be described with reference to FIG. 6.

Otherwise, in a case where the projection region is circular, the dimension information is its radius. In a case where the projection region is elliptical, the dimension information is lengths of major and minor axes. That is, the dimension information can also be said as information related to a shape in which the projection region is formed.

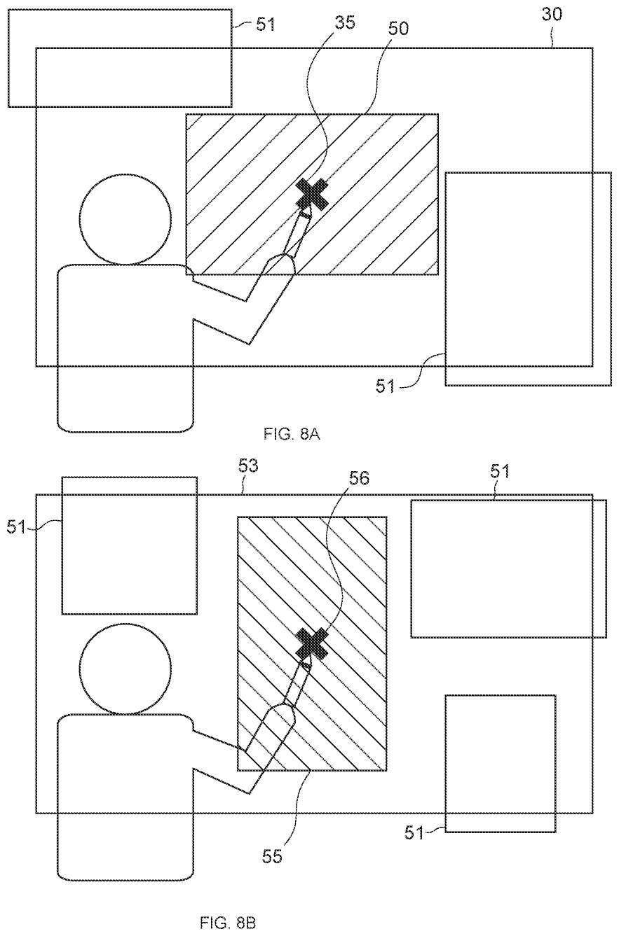

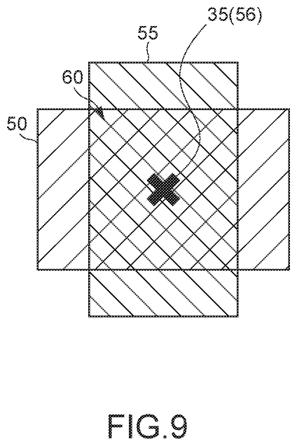

The generation unit 13 generates, on the basis of region information related to a projection region, other region information related to another projection region as a sharing location, and position information of an obstacle, a common region to the projection region and the other projection region, the common region not including the obstacle. In the present embodiment, the generation unit 13 generates an exclusively-owned projection plane not including the obstacle from the projection region and generates a region in which the exclusively-owned projection plane and another exclusively-owned projection plane overlap each other as the common region. A specific generation method for the common region will be described with reference to FIGS. 8 and 9.

The region information includes a dimension, an area, a position, and a shape. It should be noted that as the “other region information” is set forth herein, it refers to a dimension, an area, a position, and a shape of the other projection region. As the “region information of the exclusively-owned projection plane” also is set forth herein, it refers to a dimension, an area, a position, and a shape of the exclusively-owned projection plane.

The drawing unit 14 draws a virtual object projected by the image generation unit 2. In the present embodiment, the drawing unit 14 draws a virtual object with the same dimensions as each sharing location on the common region generated by the generation unit 13.

The determination unit 15 determines whether or not the common region generated by the generation unit 13 encompasses the projected virtual object. In the present embodiment, the determination unit 15 determines whether or not an area of the common region shared by each sharing location exceeds a predetermined threshold value. For example, in case where a virtual object is displayed in a rectangular shape with 5 m×4 m as the predetermined threshold value, it is determined that the common region does not encompass the virtual object when the common region is a rectangular shape with 3 m×5 m.

In the present embodiment, in a case where the determination unit 15 determines that the common region does not encompass the virtual object, this information is provided to the notification unit 16.

The notification unit 16 performs various types of notification on the user who uses the information processing system 100. In the present embodiment, in a case where the determination unit 15 determines that the common region does not encompass the virtual object, the notification unit 16 notifies the user of the fact, the user being as the sharing location which has not satisfied the determination condition. It should be noted that a notification method is not limited, and a message may be displayed on the projection region or the notification may use a voice.

The communication unit 17 communicates with the other information processing system as the sharing location via a network 20. In the present embodiment, the communication unit 17 sends position information of a projection center point and dimension information and receives position information of another projection center point and other dimension information. Moreover, the communication unit 17 sends the virtual object projected on the projection region to the sharing location.

That is, projecting a common virtual object with the same dimensions onto the common region enables remote cooperative work such as a meeting to be conducted at the A- to D-points.

It should be noted that in the present embodiment, the detection unit 11 corresponds to a detection unit that detects the obstacle.

It should be noted that in the present embodiment, the calculation unit 12 corresponds to a calculation unit that calculates a dimension of the projection region.

It should be noted that in the present embodiment, the generation unit 13 corresponds to a generation unit that generates, on the basis of region information related to a projection region on which a virtual object is projected, other region information related to another projection region different from the projection region, and position information of an obstacle that interferes with projection of the virtual object in at least one of the projection region or the other projection region, a common region to the projection region and the other projection region, the common region not including the obstacle.

It should be noted that in the present embodiment, the determination unit 15 corresponds to a determination unit that determines whether or not an area of the common region encompasses the virtual object.

It should be noted that in the present embodiment, the notification unit 16 corresponds to a notification unit that notifies of an error on the basis of a determination result of the determination unit.

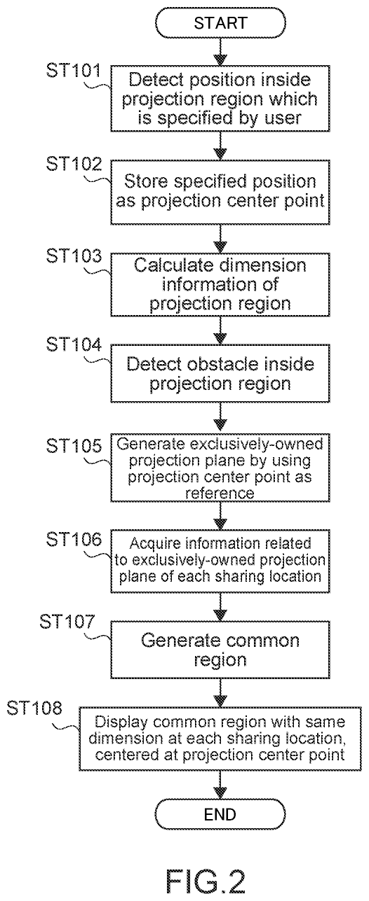

FIG. 2 is a flowchart showing generation of a common region.

As shown in FIG. 2, the detection unit 11 detects a position inside a projection region which is specified by the user, the projection region being imaged by the camera 1 (in Step 101). The position specified by the user is stored as a projection center point (in Step 102).

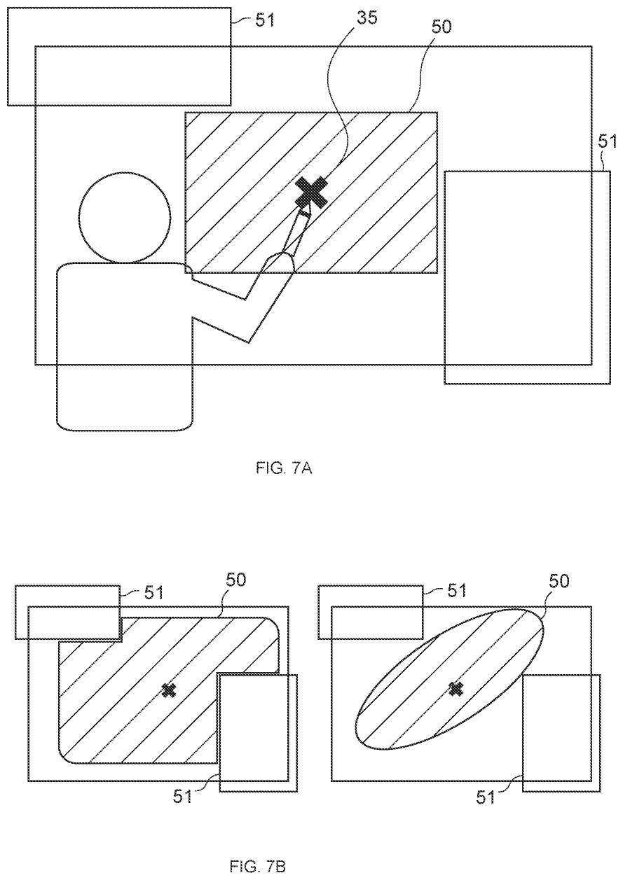

The projection center point is any position specified by the user and is used as a reference of a common region. In the present embodiment, the projection center point is a reference point for generating an exclusively-owned projection plane (see FIG. 7). Moreover, the projection center point is a reference point for making the exclusively-owned projection plane and another exclusively-owned projection plane overlap each other (see FIG. 8).

For example, the projection center point is a position easy for the user to visually recognize a virtual object. That is, the projection center point is a position that causes less burden, e.g., tilting the neck, when the user visually recognizes the virtual object. Moreover, for example, the projection center point is a position that enables the user to easily perform an operation with for example a pen device capable of writing on an interactive projector.

The calculation unit 12 calculates dimension information of the projection region (in Step 103). In the present embodiment, the calculation unit 12 calculates dimension information on the basis of the projection region imaged by the camera 1 and an object having a known length.

The detection unit 11 detects an obstacle inside the projection region (in Step 104).

The generation unit 13 generates an exclusively-owned projection plane by using the projection center point as the reference (in Step 105). In the present embodiment, the generation unit 13 generates an exclusively-owned projection plane from the projection region so as not to include the region of the obstacle detected by the detection unit 11.

The information processing system as the sharing location also executes the above-mentioned steps, i.e., storing another projection center point, calculating other dimension information, and generating another exclusively-owned projection plane. The communication unit 17 acquires information related to the exclusively-owned projection plane of each sharing location (in Step 106). In the present embodiment, a position of the other projection center point, dimension information of the other projection region, region information of the other exclusively-owned projection plane are acquired.

The generation unit 13 generates a common region (in Step 107). In the present embodiment, making the projection center point and the other projection center point overlap each other results in making the exclusively-owned projection plane and the other exclusively-owned projection plane overlap each other. A maximum overlapping region of the exclusively-owned projection plane and the other exclusively-owned projection plane is generated as the common region.

The drawing unit 14 draws the common region generated centered at the projection center point with the same dimensions (in Step 108). That is, projecting the virtual object in the generated common region enables sharing of the virtual object with the same dimensions at each sharing location.

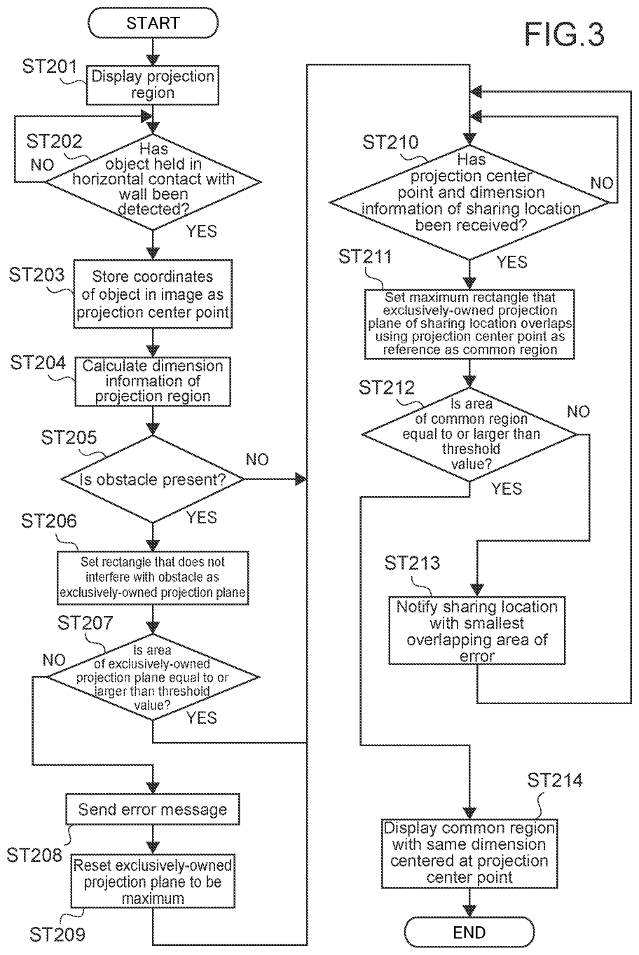

FIG. 3 is a flowchart in an example of the information processing system 100.

As shown in FIG. 3, the image generation unit 2 displays the projection region (in Step 201). The user brings an object 5 into horizontal contact with a wall on which the projection region has been displayed.

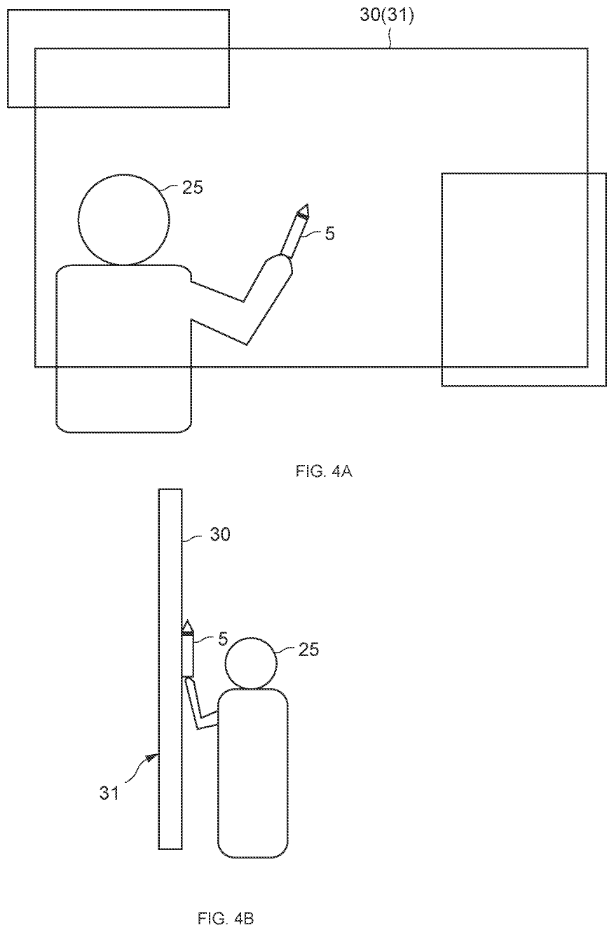

FIG. 4 is a schematic view showing a case where the user when the object is in contact with the projection region. A of FIG. 4 is a schematic view showing the projection region and the object. B of FIG. 4 is a schematic view as A of FIG. 4 is viewed in a perpendicular direction.

As shown in B of FIG. 4, a user 25 brings the object 5 (pen device) into horizontal contact with a wall 31 on which a projection region 30 has been displayed.

The detection unit 11 detects the object 5 in contact with the wall 31 (in Step 202).

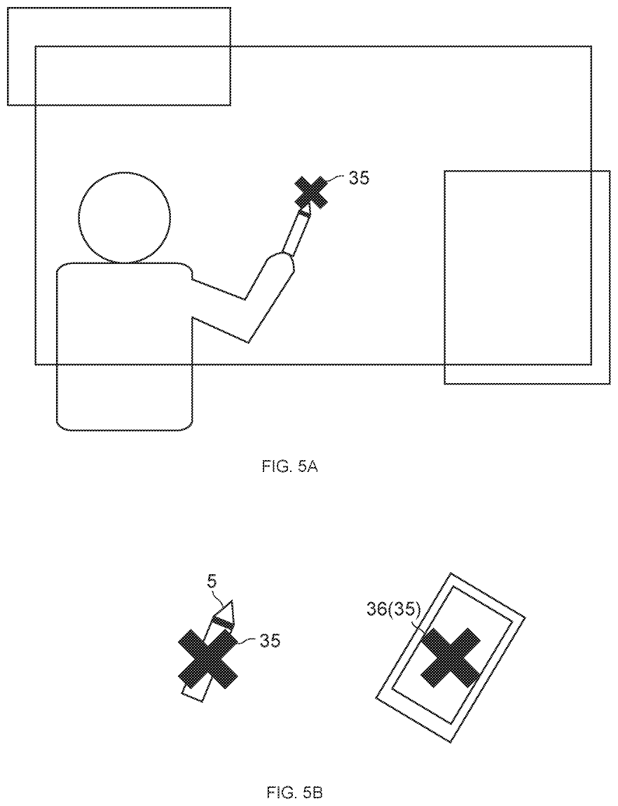

FIG. 5 is a schematic view showing the projection center point. A of FIG. 5 is a schematic view showing the object and the projection center point. B of FIG. 5 is a schematic view showing another example of the projection center point.

As shown in A of FIG. 5, in the present embodiment, a tip end of the object 5 is stored as the projection center point 35. It should be noted that a method of setting the projection center point is not limited, and as shown in B of FIG. 5, the center of weight or center position of the object 5 or the position of a predetermined mark 36 displayed on a display such as a smartphone may be stored as a projection center point.

The calculation unit 12 calculates dimension information of the projection region 30 (in Step 204).

FIG. 6 is a schematic view showing a calculation example of the dimension information. A of FIG. 6 is a schematic view showing a calculation example in a case where it is possible to image the entire projection region.

As shown in FIG. 6, the detection unit 11 detects the object 5 having a length D[m]. It should be noted that the length of the object 5 has been registered in the information processing system 100 and the object 5 is held in horizontal contact with a projection region 40 (wall) as a premise.

Moreover, the lower picture of A of FIG. 6 shows a captured image of the projection region 40. As to the projection region 40 in the captured image, the length of the shorter side is h[pix], the length of the longer side is w[pix], and the length of the object 5 is d[pix].

The calculation unit 12 calculates lengths of the shorter and longer sides of the projection region 40 on the basis of the fact that the length of the object 5 is known and the lengths in the captured image. For example, the shorter side of the projection region can be calculated by multiplying the length D [m] of the object 5 by the ratio h/d in the captured image.

B of FIG. 6 is a schematic view showing a calculation example in a case where it is impossible to image the entire projection region.

In B of FIG. 6, a grid image 41 provided with a predetermined number of grid lines overlaps the projection region 40. Here, n1 denotes the number of grid lines in a shorter-side direction, n2 denotes the number of grid lines in a longer-side direction, h[pix] denotes a length of the shorter side of the grid in the captured image, and w[pix] denotes a length of the longer side of the grid.

In this case, the shorter side of the projection region can be calculated by multiplying the length D [m] of the object 5 by the ratio h/d in the captured image and the number of grid lines n1 in the shorter-side direction.

It should be noted that in a case where the wall is tilted or in a case where the image generation unit 2 is tilted with respect to the wall, a degree of tilting of a plane may be detected based on a tilt of the pen or obstacle and the calculation may be performed. Moreover, the aspect ratio of the projection region may differ depending on the resolution of the camera 1. In this case, a guide showing horizontal and vertical directions in the projection region may be displayed. The user brings the object into contact with the wall, following the displayed guide. Moreover, in this case, the calculation unit 12 calculates dimension information in each of the horizontal and vertical directions.

It should be noted that this calculation method can also be applied to a case where the aspect ratio differs depending on the resolution of the camera or the like, for example, in a case where a sensor output ratio of 4:3 is converted into 16:9.

The detection unit 11 determines whether or not an obstacle is present inside the projection region (in Step 205). In the present embodiment, the detection unit 11 determines whether or not an object detected by an obstacle detection method shown below is an obstacle.

For example, the detection unit 11 determines whether or not it is an obstacle on the basis of a pattern projected on the projection region by the drawing unit 14. Specifically, the detection unit 11 determines a surface on which lines of a projected grid or the like are not connected when it is projected, i.e., a region having a height different from a height of the projection region as an obstacle.

Moreover, for example, the detection unit 11 determines whether or not it is an obstacle by triangulation in a case where a distance between the camera 1 and the image generation unit 2 is fixed, i.e., in a case where the distance is constant and known. Moreover, in a case where fields of view (FOV) of the camera 1 and the image generation unit 2 are known, an angle to a point wished to be measured based on deviations from center positions of the camera 1 and the image generation unit 2 can be calculated.

Moreover, for example, the detection unit 11 determines whether or not it is an obstacle on the basis of brightness of the projection region. Specifically, the detection unit 11 determines a brighter region as an obstacle because reflection on a region of the projection region, which is closer to the camera 1, is brighter and reflection on a region of the projection region, which is further from the camera 1, is darker.

Moreover, for example, the detection unit 11 determines whether or not it is an obstacle by edge detection or object detection from the captured image captured by the camera 1.

The generation unit 13 generates an exclusively-owned projection plane (in Step 206). The exclusively-owned projection plane refers to a region that does not interfere with the obstacle inside the projection region.

FIG. 7 is a schematic view showing an example of the exclusively-owned projection plane.

In the present embodiment, an exclusively-owned projection plane 50 is generated in a rectangular shape centered at a projection center point 35 as shown in A of FIG. 7. It should be noted that the shape of the exclusively-owned projection plane 50 is not limited. For example, as shown in B of FIG. 7, an exclusively-owned projection plane 50 may be generated along the outer peripheries of obstacles 51 or an elliptical exclusively-owned projection plane 50 may be generated.

Moreover, the user may set a shape of the exclusively-owned projection plane. In this case, the user may draw an exclusively-owned projection plane with a pen device or the like and the region of this exclusively-owned projection plane may include the obstacle region (s). That is, the user may set a part or whole of the region (s) determined as the obstacle (s) as the exclusively-owned projection plane.

The determination unit 15 determines whether or not an area of the exclusively-owned projection plane is equal to or larger than a threshold value (in Step 207). For example, the determination unit 15 determines whether or not the exclusively-owned projection plane encompasses the projected virtual object. It should be noted that the threshold value for the area of the exclusively-owned projection plane may be set as appropriate.

In a case where the area of the exclusively-owned projection plane is equal to or smaller than the threshold value (in NO in Step 207), the notification unit 16 sends an error message (in Step 208). For example, the notification unit 16 notifies the user of an error, e.g., “the available region (exclusively-owned projection plane) is narrow”.

The generation unit 13 resets the exclusively-owned projection plane to be maximum (in Step 209). For example, the generation unit 13 adjusts the position of the projection center point specified by the user and generates the exclusively-owned projection plane to a maximum area.

In a case where the area of the exclusively-owned projection plane is equal to or larger than the threshold value (in YES in Step 207), the communication unit 17 determines whether or not it has received a projection center point and dimension information of the sharing location (in Step 210). In the present embodiment, since the sharing devices are the B-point, the C-point, and the D-point, the communication unit 17 determines whether or not it has received all projection center points and dimension information of the sharing locations.

FIG. 8 is a schematic view showing an example of the exclusively-owned projection plane and the other exclusively-owned projection plane. A of FIG. 8 is a schematic view showing an example of the exclusively-owned projection plane. B of FIG. 8 is a schematic view showing an example of the other exclusively-owned projection plane.

The communication unit 17 receives another projection center point 56 in B of FIG. 8 as the sharing location and other dimension information of another projection region 53. For example, the communication unit 17 receives coordinates of the other projection center point 56 or lengths of longer and shorter sides of another exclusively-owned projection plane 55.

The generation unit 13 makes the other projection center point overlap the projection center point and sets a maximum region in which the exclusively-owned projection plane and the other exclusively-owned projection plane overlap each other as the common region (in Step 211).

FIG. 9 is a schematic view showing an example of the common region. It should be noted that in FIG. 9, only two exclusively-owned projection planes are shown for the sake of simplification.

As shown in FIG. 9, in the present embodiment, the generation unit 13 overlaps coordinates of the projection center point 35 on coordinates of the other projection center point 56. Accordingly, the exclusively-owned projection plane 50 and the other exclusively-owned projection plane 55 overlap each other and this overlapping region is set as a common region 60.

The exclusively-owned projection plane 50 and the other exclusively-owned projection plane 55 shown in FIG. 9 may be displayed on the projection regions of the users (the A-point, the B-point, the C-point, and the D-point). Moreover, the user of the A-point may adjust his or her exclusively-owned projection plane in accordance with the exclusively-owned projection plane of the sharing location. For example, the user of the A-point may extend the exclusively-owned projection plane by an action, e.g., moving the obstacle or moving the projection center point. Moreover, in this case, the adjusted exclusively-owned projection plane may be updated at the sharing location in real time.

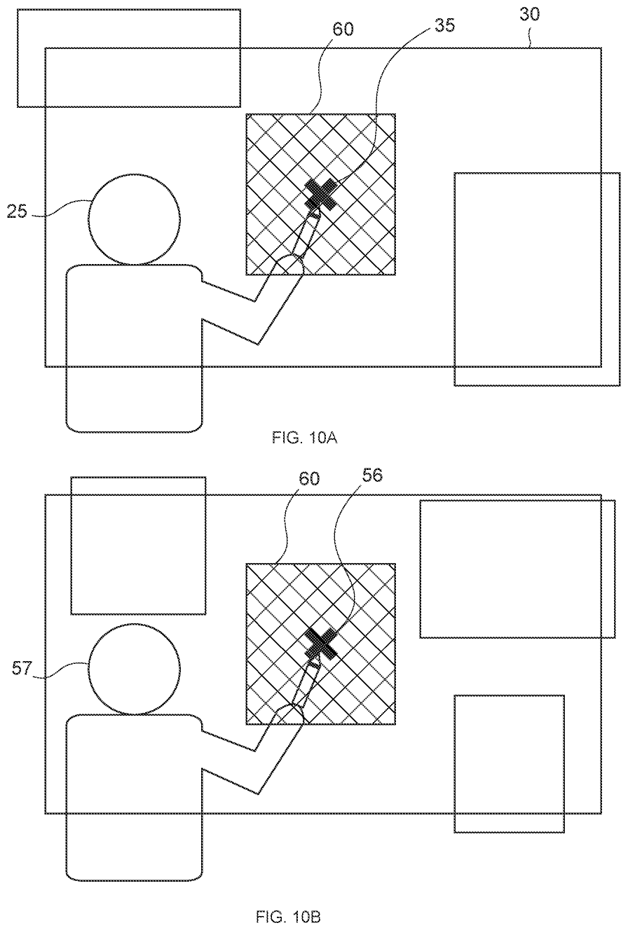

FIG. 10 is a schematic view showing an example of the common region. A of FIG. 10 is a schematic view showing an example of the common region. B of FIG. 10 is a schematic view showing another example of the common region.

As shown in FIG. 10, the generated common region 60 is shared by each sharing location. A virtual object is projected on the shared common region 60. Only the common region 60 is shown in FIG. 10, though not limited thereto. The exclusively-owned projection plane 50 in FIG. 8 may be simultaneously projected. That is, the user 25 may recognize a region that a user 57 as the sharing location cannot see. A graphical user interface (GUI) such as a palette or a virtual object other than the shared virtual object may be displayed on for example the region (projection region 30 other than the common region 60) that the user 57 cannot see.

The determination unit 15 determines whether or not an area of the common region is equal to or larger than a threshold value (in Step 212). In the present embodiment, the determination unit 15 determines whether or not an area of the common region generated by the information processing system 100 of the A-point is equal to or larger than a threshold value.

In a case where the area of the common region is equal to or smaller than the threshold value (in NO in Step 212), the notification unit 16 notifies the sharing location whose overlapping area is the smallest of an error (in Step 213). For example, in a case where the area of the common region in the area of the exclusively-owned projection plane of the A-point is 60%, the area of the common region in the area of the exclusively-owned projection plane of the B-point is 50%, the area of the common region in the area of the exclusively-owned projection plane of the C-point is 70%, and the area of the common region in the area of the exclusively-owned projection plane of the D-point is 80%, the notification unit 16 notifies the user of the B-point of an error that prompts the user to perform resetting, saying “redo in a wider area”.

In a case where the B-point has been notified of the error, the information processing system of the A-point returns to Step 210 of the flow. That is, the users of the A-point, the C-point, and the D-point wait for the projection center point and the dimension information of the B-point to be sent.

In a case where the B-point has been notified of the error, the information processing system of the B-point returns to each step of the flow depending on a situation. For example, in a case where it is possible to move the obstacle, the information processing system of the B-point returns to Step 205. Moreover, for example, in a case where it is possible to adjust the position or area of the exclusively-owned projection plane, the information processing system of the B-point returns to Step 207. Moreover, for example, in a case of changing the wall surface on which the projection region is projected, the information processing system of the B-point returns to Step 201.

Moreover, in this case, a GUI for presenting an instruction to shift to each flow may be displayed.

In a case where the area of the common region is equal to or larger than the threshold value (in YES in Step 212), the common region is displayed with the same dimensions, centered at the projection center point as shown in FIG. 10 (in Step 213).

It should be noted that the determination unit and the notification unit of the sharing location may execute the determination in Step 212 or the notification in Step 213.

As described above, the information processing apparatus 10 according to the present embodiment generates the common region 60 not including the obstacles 51 on the basis of region information 30 related to a projection region on which a virtual object is projected, another region information related to another projection region 53 different from the projection region 30, and position information of obstacles 51 that interfere with projection of the virtual object in at least one of the projection region 30 or the other projection region 53. This enables content sharing.

In recent years, there is an increasing demand for performing cooperative work with a remote worker via a network in the world situation. Conventionally, a plurality of people has shared a single projection region generated by a projector or the like for performing work. In the remote cooperative work, remote workers can work by using a projection region in their environment. In such a situation, there is a problem in that dimensions of a projection object differ depending on each environment. For example, the dimensions of the projection object are important information for poster design or the like, and differences in dimensions depending on each environment can lead to a discrepancy in communication, which will lower work performance.

In the present technology, the camera on the system side images the object having the known length and the dimensions of the projection plane are calculated. Moreover, the position of the projection plane is determined by using the position specified by the worker as the center. Moreover, the region on which projection can be performed is set by detecting the obstacle (s) and determining the projection plane. Performing those operations in each remote system allows adjustment of the dimensions of all the projection planes.

That is, in the present technology, a consistent projection plane with common dimensions can be generated by generating, in each remote system, the common projection region having the same dimensions with which no obstacle interferes.

### OTHER EMBODIMENTS

The present technology is not limited to the above-mentioned embodiment, and various other embodiments can be made.

In the above-mentioned embodiment, the object whose length is known is used for calculating the dimension information. The present technology is not limited thereto, and the dimension information may be calculated by various methods. For example, the information processing system may include a distance measurement sensor for measuring a distance to a projection plane such as a wall.

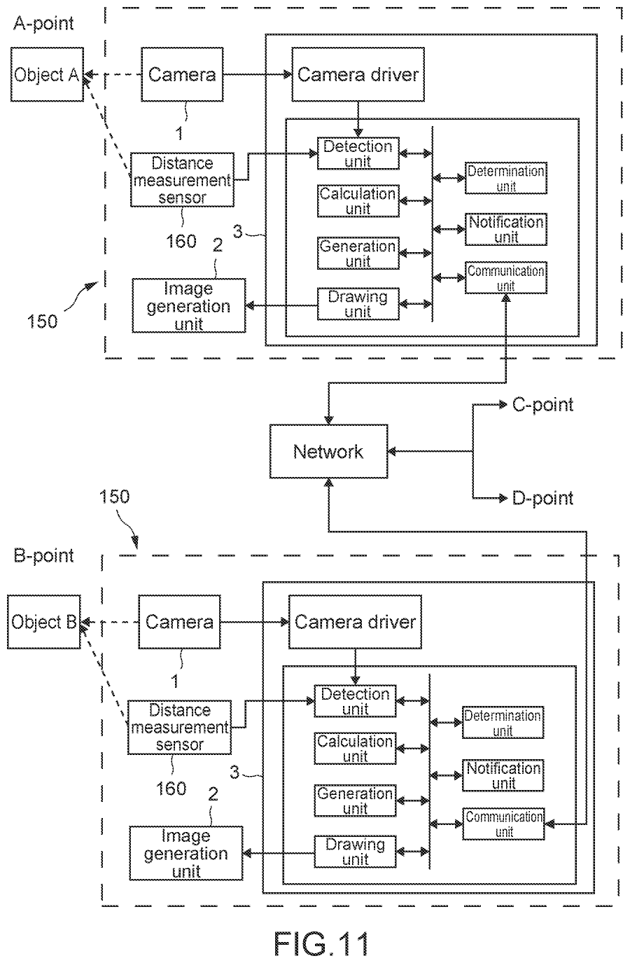

FIG. 11 is a diagram schematically showing an information processing system according to another embodiment. In the following description, descriptions of portions similar to configurations and actions in the information processing system 100 described in the above-mentioned embodiment will be omitted or simplified.

As shown in FIG. 11, an information processing system 150 includes a distance measurement sensor 160 in addition to a camera 1, an image generation unit 2, and a main body terminal 3.

The distance measurement sensor 160 measures a distance to a projection plane. The distance measurement sensor 160 may be any sensor as long as it can measure a distance. For example, an infrared distance measurement sensor, an ultrasonic sensor, a light detection and ranging (LiDAR), a time of flight (ToF) camera, a millimeter-wave radar, a stereo camera, or the like may be used.

Moreover, the detection unit 11 is provided with a distance to the projection plane acquired by the distance measurement sensor 160.

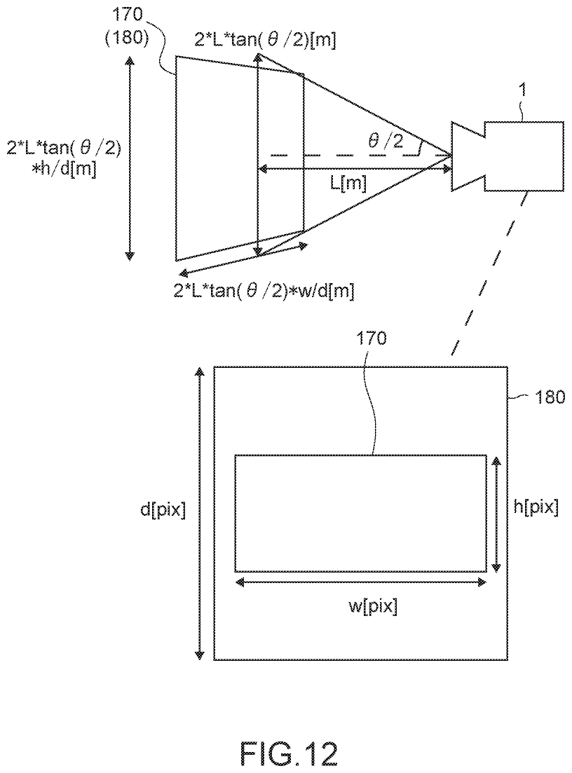

FIG. 12 is a schematic view showing a calculation example of dimension information in a case of using the distance measurement sensor.

As shown in FIG. 12, the distance measurement sensor 160 measures a distance L[m] to a projection region 170 from the camera 1. In FIG. 12, the calculation unit 12 calculates a length 2Ltan (θ/2) [m] of one side of an image allowable region 180 of the camera 1 because the FOV of the camera 1 is 0.

Moreover, the lower picture in FIG. 12 shows a captured image of the projection region. As to the projection region 170 in the captured image, the length of the shorter side is h[pix], the length of the longer side is w[pix], and the length of the image allowable region 180 is d[pix].

The calculation unit 12 calculates lengths of shorter and longer sides of the projection region 170 on the basis of the length 2Ltan (θ/2) [m] of the image allowable region 180 of the camera 1 and the lengths in the captured image d[pix]. For example, the shorter side of the projection region 170 can be calculated by multiplying the length 2Ltan (θ/2) [m] of the image allowable region 180 by the ratio h/d in the captured image.

It should be noted that in FIG. 12, the image allowable region 180 is square. In a case where the image allowable region 180 is rectangular, the dimension information of the projection region 170 is calculated, assuming that d1 denotes a shorter side, d2 denotes a longer side, θ1 denotes an angle of view in a shorter-side direction, and θ2 denotes an angle of view in a longer-side direction.

Moreover, in a case where the information processing system has the distance measurement sensor 160, the user may perform detection of a position inside the projection region and setting of the projection center point in Steps 101 and 102 and in Steps 202 and 203 with the finger or the like. For example, a tip end of the finger may be stored as a projection center point.

In the above-mentioned embodiment, the user is notified of an error in a case where an area of the common region generated by the generation unit 13 is equal to or smaller than a threshold value. The present technology is not limited thereto, and determination may be performed on the common region in accordance with various conditions. The user is notified of an error for example in a case where dpi (dots per inch) of a sharing location is significantly different. In this case, the higher dpi of the projection plane may be made equal to the lower dpi. Moreover, the information processing system with the higher dpi may be notified of an instruction to perform readjustment to move the position away.

In the above-mentioned embodiment, the projection center point and the dimension information of the sharing location are acquired and the common region is set. The present technology is not limited thereto, and the common region may be set on the basis of an environment of a master.

For example, in a case where the information processing system 100 of the A-point is set as a master, a projection center point specified under an environment at the A-point is shared by a sharing location. That is, a sharing location (slave) other than the master uses settings of each sharing location for a horizontal position (position in a direction perpendicular to the height) of each projection center point and uses a height set by the master only as a height of the projection center point.

Any method may be used as a method of detecting a height of the projection center point of the sharing location. For example, in a case where the camera is capable of imaging a floor, it may be determined by a method similar to the method of calculating the dimension information as shown in FIG. 6. Alternatively, for example, in a case where the camera 1 is incapable of imaging the floor, the height may be measured by the distance measurement sensor 160, a sound of hitting the floor which is obtained by making an object freely fall from the projection center point may be detected, or a sound of hitting the floor which is obtained by the user moving an object to the floor from the projection center point may be detected. When the sound is detected, the height is estimated based on a time duration until the object hits the floor after the object falls and a movement velocity (fall velocity). Moreover, the velocity may be calculated based on frames per second (FPS) and a movement displacement of the camera 1.

In the above-mentioned embodiment, the detection unit 11 detects the obstacle after the projection center point is stored. The present technology is not limited thereto, and the timing for detecting the obstacle may be determined as appropriate. For example, the obstacle may be detected at the time of adjustment such as distortion correction for the projector. Moreover, for example, the obstacle may be detected from some candidates of the wall surface on which the projection region is projected and whether the candidates are suitable for generating the exclusively-owned projection plane and the common region may be determined.

In the above-mentioned embodiment, the projector is used as the image generation unit 2. The present technology is not limited thereto, and a variety of image display apparatuses may be used. For example, the image generation unit may be an augmented reality (AR) glass.

In a case where the image generation unit 2 is an AR glass, the common region is generated following the chart below.

The user specifies a position on a plane with the finger or with an object that can be recognized by the AR glass.

The specified position is stored as a projection center point.

The distance measurement sensor of the AR glass measures a distance to the plane.

The distance measurement sensor of the AR glass detects an obstacle different in height on the plane.

An exclusively-owned projection plane is generated using the projection center point on the AR glass as the center.

The projection center point and the dimension information of the AR glass of the sharing location are received.

The projection center points of the respective exclusively-owned projection planes overlap each other inside the AR glass and a maximum overlapping region is set as the common region.

The generated common region is made to overlap using the projection center point of the sharing location as the center.

Moreover, the present technology can be applied to both a case where the image generation unit is the projector and a case where the image generation unit is the AR glass. The present technology can also be applied to a variety of combinations in accordance with the number of sharing locations, for example, in a case where the A-point is AR glass and the B-point is the projector.

In a case of such a combination, a common region is generated following the chart below.

The projector side executes Steps 101 to 105 shown in FIG. 2.

The projector sends dimension information of the projection region on the projector side to the AR glass.

A projection center point is set by using an object that can be recognized by the AR glass or a hand.

The distance measurement sensor of the AR glass recognizes an obstacle.

A common region is set on the AR glass side.

The common region generated on the AR glass side is sent to the projector side.

Moreover, the technology can be applied to both a case where the image generation unit 2 is the projector and a case where the image generation unit 2 is the virtual reality (VR) goggles. The common region is generated following the chart below.

The projector side executes Steps 101 to 105 shown in FIG. 2.

The projector side displays a projection region on a wall surface with a dimension of the projection region.

The projector side sends the dimension information of the projection region of the projector to the VR goggles side.

The VR goggles side sets a three-dimensional position of the projection center point through a controller or the like.

A common region is generated using the set three-dimensional position as the center.

In the above-mentioned embodiment, the virtual object is projected as the two-dimensional image on the projection region. The present technology is not limited thereto, and a 3D virtual object may be projected in a space.

FIG. 13 is a block diagram showing hardware configuration examples of the information processing apparatus 10.

The information processing apparatus 10 includes a CPU 201, a ROM 202, a RAM 202, an input/output interface 205, and a bus 204 that connects them to one another. A display unit 206, an input unit 207, a storage unit 208, a communication unit 209, a drive unit 210, and the like are connected to the input/output interface 205.

The display unit 206 is, for example, a display device using liquid crystals, EL, or the like. The input unit 207 is, for example, a keyboard, a pointing device, a touch panel, or another operation device. In a case where the input unit 207 includes a touch panel, the touch panel can be integral with the display unit 206.

The storage unit 208 is a nonvolatile storage device. The storage unit 208 is, for example, an HDD, a flash memory, or another solid-state memory. The drive unit 210 is, for example, a device capable of driving a removable recording medium 211 such as an optical recording medium and a magnetic record tape.

The communication unit 209 is a modem, a router, or another communication device for communicating with other devices, which is connectable to a LAN, a WAN, or the like. The communication unit 209 may perform wired communication or may perform wireless communication. The communication unit 209 is often used separately from the information processing apparatus 10.

Cooperation of software stored in the storage unit 208, the ROM 202, or the like with hardware resources of the information processing apparatus 10 achieves information processing of the information processing apparatus 10 having the hardware configurations as described above. Specifically, loading a program that configures the software, which has been stored in the ROM 202 or the like, to the RAM 202 and executing it achieves the information processing method according to the present technology.

The information processing apparatus 10 installs the program via the recording medium 211, for example. Alternatively, the information processing apparatus 10 may install the program via a global network or the like. Otherwise, any computer-readable non-transitory storage medium may be used.

Cooperation of a computer mounted on a communication terminal with another computer capable of communicating with it via a network or the like may execute the information processing method and the program according to the present technology and configure the generation unit according to the present technology.

That is, the information processing apparatus, the information processing method, the program, and the information processing system according to the present technology may be performed not only in a computer system constituted by a single computer but also in a computer system in which a plurality of computers cooperatively operates. It should be noted that in the present disclosure, the system means a set of a plurality of components (e.g., apparatuses, modules (parts)) and it does not matter whether or not all the components are housed in the same casing. Therefore, both of a plurality of apparatuses housed in separate casings and connected to one another via a network and a single apparatus having a plurality of modules housed in a single casing are the system.

Executing the information processing apparatus, the information processing method, the program, and the information processing system according to the present technology by the computer system includes, for example, both of a case where a single computer executes the exclusively-owned projection plane generation, the obstacle detection, and the common region generation, and the like and a case where different computers execute the respective processes. Moreover, executing the respective processes by a predetermined computer includes causing another computer to execute some or all of those processes and acquiring the results.

That is, the information processing apparatus, the information processing method, the program, and the information processing system according to the present technology can also be applied to a cloud computing configuration in which a plurality of apparatuses shares and cooperatively processes a single function via a network.

The respective configurations such as the detection unit, the generation unit, and the determination unit, the control flow of the communication system, and the like, which have been described with reference to the respective drawings, are merely embodiments, and can be modified as appropriate without departing from the gist of the present technology. That is, any other configurations, algorithms, and the like for carrying out the present technology may be employed.

It should be noted that the effects described in the present disclosure are merely exemplary and not limitative, and further other effects may be provided. The description of the plurality of effects above does not necessarily mean that those effects are provided at the same time. It means that at least any one of the above-mentioned effects is obtained depending on a condition and the like, and effects not described in the present disclosure can be provided as a matter of course.

At least two features of the features of the above-mentioned embodiments may be combined. That is, the various features described in the respective embodiments may be combined as appropriate across the respective embodiments.

It should be noted that the present technology can also take the following configurations.

(1) An information processing apparatus, including
a generation unit that generates, on the basis of region information related to a projection region on which a virtual object is projected, other region information related to another projection region different from the projection region, and position information of an obstacle that interferes with projection of the virtual object in at least one of the projection region or the other projection region, a common region to the projection region and the other projection region, the common region not including the obstacle.

(2) The information processing apparatus according to (1), in which
the region information includes a dimension of the projection region, an area of the projection region, a position of the projection region, and a shape of the projection region, and
the other region information includes a dimension of the other projection region, an area of the other projection region, a position of the other projection region, and a shape of the other projection region.

(3) The information processing apparatus according to (1), further including
a detection unit that detects the obstacle.

(4) The information processing apparatus according to (3), in which
the detection unit detects the object as the obstacle on the basis of object information related to an object included in the projection region.

(5) The information processing apparatus according to (4), in which
the object information includes a depth of the object, a tilt of the object, a material of the object, a color of the object, and brightness of the object.

(6) The information processing apparatus according to (5), in which
the detection unit detects the object having a depth different from the depth of the projection region as the obstacle.

(7) The information processing apparatus according to (1), in which
the projection region includes a center point,
the other projection region includes another center point, and
the generation unit makes the center point and the other center point overlap each other and generates the common region.

(8) The information processing apparatus according to (1), in which
the generation unit generates the common region with an identical dimension on the basis of a dimension of the projection region and a dimension of the other projection region.

(9) The information processing apparatus according to (7), in which
the generation unit makes the center point and the other center point overlap each other and generates a region in which the projection region and the other projection region overlap each other as the common region.

(10) The information processing apparatus according to (1), further including
a determination unit that determines whether or not an area of the common region encompasses the virtual object.

(11) The information processing apparatus according to (10), in which
the determination unit further determines whether or not an area of the common region is equal to or larger than a threshold value.

(12) The information processing apparatus according to (1), further including
a calculation unit that calculates a dimension of the projection region.

(13) The information processing apparatus according to (10), further including
a notification unit that notifies of an error on the basis of a determination result of the determination unit.

(14) An information processing method, including
by a computer system
generating, on the basis of region information related to a projection region on which a virtual object is projected, other region information related to another projection region different from the projection region, and position information of an obstacle that interferes with projection of the virtual object in at least one of the projection region or the other projection region, a common region to the projection region and the other projection region, the common region not including the obstacle.

(15) A program that causes a computer system to execute
a step of generating, on the basis of region information related to a projection region on which a virtual object is projected, other region information related to another projection region different from the projection region, and position information of an obstacle that interferes with projection of the virtual object in at least one of the projection region or the other projection region, a common region to the projection region and the other projection region, the common region not including the obstacle.

(16) An information processing system, including:
a camera that images a projection region on which a virtual object is projected;
an information processing apparatus including a generation unit that generates, on the basis of region information related to a projection region on which a virtual object is projected, other region information related to another projection region different from the projection region, and position information of an obstacle that interferes with projection of the virtual object in at least one of the projection region or the other projection region, a common region to the projection region and the other projection region, the common region not including the obstacle; and
an image generation unit that projects the virtual object.

(17) The information processing system according to (16), further including
a communication unit that sends and receives data to and from another information processing system including
   another camera that images the other projection region on which the virtual object is projected,
   another information processing apparatus including another generation unit that generates the common region on the basis of the region information, the other region information, and the position information, and
   another image generation unit that projects the virtual object.

(18) The information processing system according to (17), in which
the communication unit sends the region information and the position information to the other information processing system and receives the other region information and the position information.

(19) The information processing system according to (16), in which
the image generation unit includes a projector, an augmented reality glass, and virtual reality goggles.

(20) The information processing system according to (16), further including
a distance measurement sensor that measures a distance to the projection region.

### REFERENCE SIGNS LIST

10 information processing apparatus
11 detection unit
12 calculation unit
13 generation unit
15 determination unit
16 notification unit
17 communication unit
30 projection region
35 projection center point
50 exclusively-owned projection plane
60 common region

1. An information processing apparatus, comprising
a generation unit that generates, on a basis of region information related to a projection region on which a virtual object is projected, other region information related to another projection region different from the projection region, and position information of an obstacle that interferes with projection of the virtual object in at least one of the projection region or the other projection region, a common region to the projection region and the other projection region, the common region not including the obstacle.

2. The information processing apparatus according to claim 1, wherein
the region information includes a dimension of the projection region, an area of the projection region, a position of the projection region, and a shape of the projection region, and
the other region information includes a dimension of the other projection region, an area of the other projection region, a position of the other projection region, and a shape of the other projection region.

3. The information processing apparatus according to claim 1, further comprising
a detection unit that detects the obstacle.

4. The information processing apparatus according to claim 3, wherein
the detection unit detects the object as the obstacle on a basis of object information related to an object included in the projection region.

5. The information processing apparatus according to claim 4, wherein
the object information includes a depth of the object, a tilt of the object, a material of the object, a color of the object, and brightness of the object.

6. The information processing apparatus according to claim 5, wherein
the detection unit detects the object having a depth different from the depth of the projection region as the obstacle.

7. The information processing apparatus according to claim 1, wherein
the projection region includes a center point,
the other projection region includes another center point, and
the generation unit makes the center point and the other center point overlap each other and generates the common region.

8. The information processing apparatus according to claim 1, wherein
the generation unit generates the common region with an identical dimension on a basis of a dimension of the projection region and a dimension of the other projection region.

9. The information processing apparatus according to claim 7, wherein
the generation unit makes the center point and the other center point overlap each other and generates a region in which the projection region and the other projection region overlap each other as the common region.

10. The information processing apparatus according to claim 1, further comprising
a determination unit that determines whether or not an area of the common region encompasses the virtual object.

11. The information processing apparatus according to claim 10, wherein
the determination unit determines whether or not an area of the common region is equal to or larger than a threshold value.

12. The information processing apparatus according to claim 1, further comprising
a calculation unit that calculates a dimension of the projection region.

13. The information processing apparatus according to claim 10, further comprising
a notification unit that notifies of an error on a basis of a determination result of the determination unit.

14. An information processing method, comprising
by a computer system
generating, on a basis of region information related to a projection region on which a virtual object is projected, other region information related to another projection region different from the projection region, and position information of an obstacle that interferes with projection of the virtual object in at least one of the projection region or the other projection region, a common region to the projection region and the other projection region, the common region not including the obstacle.

15. A program that causes a computer system to execute
a step of generating, on a basis of region information related to a projection region on which a virtual object is projected, other region information related to another projection region different from the projection region, and position information of an obstacle that interferes with projection of the virtual object in at least one of the projection region or the other projection region, a common region to the projection region and the other projection region, the common region not including the obstacle.

16. An information processing system, comprising:
a camera that images a projection region on which a virtual object is projected;
an information processing apparatus including a generation unit that generates, on a basis of region information related to a projection region on which a virtual object is projected, other region information related to another projection region different from the projection region, and position information of an obstacle that interferes with projection of the virtual object in at least one of the projection region or the other projection region, a common region to the projection region and the other projection region, the common region not including the obstacle; and
an image generation unit that projects the virtual object.

17. The information processing system according to claim 16, further comprising
a communication unit that sends and receives data to and from another information processing system including
another camera that images the other projection region on which the virtual object is projected,
another information processing apparatus including another generation unit that generates the common region on a basis of the region information, the other region information, and the position information, and
another image generation unit that projects the virtual object.

18. The information processing system according to claim 17, wherein
the communication unit sends the region information and the position information to the other information processing system and receives the other region information and the position information.

19. The information processing system according to claim 16, wherein
the image generation unit includes a projector, an augmented reality glass, and virtual reality goggles.

20. The information processing system according to claim 16, further comprising
a distance measurement sensor that measures a distance to the projection region.
